(19) United States
(12) Patent Application Publication
(10) Pub. No.: US 2019/0143616 A1
(43) Pub. Date: May 16, 2019

(54) METHOD AND APPARATUS FOR MANUFACTURING OPTICAL SHEET MODULE

(71) Applicant: LMS CO., LTD., Pyeongtaek-si, Gyeonggi-do (KR)

(72) Inventor: Jee Hong MIN, Seongnam-si, Gyeonggi-do (KR)

(73) Assignee: LMS CO., LTD., Pyeongtaek-si, Gyeonggi-do (KR)

(21) Appl. No.: 16/306,844

(22) PCT Filed: Jun. 2, 2017
(86) PCT No.: PCT/KR2017/005773

§ 371 Date: Dec. 3, 2018

(30) Foreign Application Priority Data
Jun. 3, 2016 (KR) 10-2016-0069606
Jun. 2, 2017 (KR) 10-2017-0068750

(51) Int. Cl. B29D 11/00

(52) U.S. Cl. CPC B29D 11/0073; B29D 11/00865

(57) ABSTRACT

The present invention relates to a method for manufacturing an optical sheet module, and the method comprises: a first pattern formation step of coating a top surface of a first base film with a liquid-state source material so as to form a first structured pattern; a provisional pattern curing step of semi-curing the first structured pattern while maintaining its shape; an adhesive layer coating step of coating a surface of a second base film with an adhesive layer; a provisional adhesive layer curing step of semi-curing the adhesive layer coated on the second base film; an adhesion step of adhering at least a part of the first structured pattern of the first base film to a bottom surface of the second base film; and a main curing step of curing the first structured pattern while the first base film and the second base film are adhered.

### TECHNICAL FIELD

The present invention relates to a method and apparatus for manufacturing an optical sheet module, and more particularly, to a method and apparatus for manufacturing an optical sheet module capable of easily adhering to a plurality of optical sheets and having an improved adhesion quality.

### BACKGROUND ART

Liquid crystal display devices are display devices used for laptop computers, desktop computers, smart phones, televisions, and the like. As demand for liquid crystal display devices has increased, the characteristics of liquid crystal display devices have also changed and improved every year.

A liquid crystal panel of a liquid crystal display device, which is a non-light emitting device, requires a backlight unit because of its structure. The backlight unit is composed of various optical systems. In addition, the backlight unit uses a periodic array of optical films to improve luminance.

Referring to the conventional process of manufacturing a bond type optical sheet module, when a triangle prism type optical sheet module having a prism pattern formed in an upward direction is manufactured, a pair of upper and lower optical sheets are stacked and bonded to each other.

In this case, a structured pattern is formed on both the upper optical sheet and the lower optical sheet.

In this case, the structured pattern formed on the lower optical sheet is in contact with a bottom surface of the upper optical sheet, or is bonded to the bottom surface of the upper optical sheet with a different adhesive.

However, since the structured pattern is formed on a top surface of the upper optical sheet when the upper optical sheet and the lower optical sheet are bonded in this manner, it is difficult to press the upper optical sheet and the lower optical sheet using a conventional roller.

Particularly, in cases in which it is not possible to press the upper optical sheet and the lower optical sheet using a conventional roller, it is difficult to adequately press the upper optical sheet and the lower optical sheet and to have a uniform distance when the upper optical sheet and the lower optical sheet are bonded, and thus the quality of the optical sheet module is lowered.

### DISCLOSURE

### Technical Problem

In order to solve the problems related to a conventional optical sheet module, the present invention is directed to providing a method and apparatus for manufacturing an optical sheet module, in which a semi-cured first structured pattern is formed on a first base film, a second base film is subsequently bonded to an upper part of the first structured pattern, the first structured pattern is cured to form a bonded structure, and a second structured pattern is additionally formed, thereby improving the bonding quality of the base films.

The present invention is also directed to providing an optical sheet module manufactured by the method for manufacturing an optical sheet module.

The present invention is also directed to providing an optical sheet module capable of minimizing the degradation of bonding quality and luminance.

### Technical Solution

One aspect of the present invention is to provide a method for manufacturing an optical sheet module which includes a first pattern formation step of coating a top surface of a first base film with a liquid-state source material so as to form a first structured pattern, a provisional pattern curing step of semi-curing the first structured pattern while maintaining its shape, an adhesive layer coating step of coating a surface of a second base film with an adhesive layer, a provisional adhesive layer curing step of semi-curing the adhesive layer coated on the second base film, an adhesion step of adhering at least a part of the first structured pattern of the first base film to a bottom surface of the second base film, and a main curing step of curing the first structured pattern while the first base film and the second base film are being adhered.

Further, the method may further include a second pattern formation step of coating a top surface of the second base film that has been subjected to the main curing step with a liquid-state source material so as to form a second structured pattern, and a pattern curing step of curing the second structured pattern.

Further, the adhesive layer may be formed to have a preset pattern.

Further, the first pattern formation step may include a first process of coating the top surface of the first base film with the liquid-state source material of the first structured pattern and a second process of forming the first structured pattern by pressing a first pattern formation part in which a preset pattern is formed onto the source material with which the first base film is coated.

Further, the first pattern formation part may be formed as any one of a pattern roller and a circulating pattern belt having a preset pattern formed on a surface thereof which is in contact with the source material of the first structured pattern.

Further, the first structured pattern may have a pitch or a vertical height different from that of the second structured pattern.

Further, the first structured pattern, the second structured pattern, and the adhesive layer may be comprised of ultraviolet (UV) curable materials.

Further, the first structured pattern and the second structured pattern may include at least one of an acrylate monomer, diacrylate monomer, urethane acrylate oligomer, polyester acrylate oligomer, epoxy acrylate oligomer, and high refractive acrylate monomer.

Further, the adhesive layer may include an acrylate monomer, diacrylate monomer, urethane acrylate oligomer, polyester acrylate oligomer, and epoxy acrylate oligomer.

Another aspect of the present invention provides an apparatus for manufacturing an optical sheet module which includes a first process unit including a first transfer path through which a first base film in a form of a sheet is transferred, a first pattern formation part configured to form a first structured pattern on a top surface of the first base film on the first transfer path, a provisional pattern curing part configured to semi-cure the first structured pattern formed by the first pattern formation part so as to maintain a shape of the first structured pattern, a second transfer path provided separately from the first transfer path and through which a second base film in a form of a sheet is transferred, an adhesive layer coating part provided on the second transfer path and configured to form an adhesive layer on a surface of the second base film which is transferred onto the second transfer path, a provisional adhesive layer curing part provided on the second transfer path and configured to semi-cure the adhesive layer which is transferred onto the second transfer path, an integrated transfer path connected to each of downstream sides of the first transfer path and the second transfer path to be merged with each other and through which the first base film and the second base film are transferred, a bonding roller provided on the integrated transfer path and configured to stack the second base film on the first base film and bond the first structured pattern to the adhesive layer by pressing upward and downward, and a main curing part configured to cure the first structured pattern and the adhesive layer which are bonded on the integrated transfer path, and a second process unit including a third transfer path provided separately from the integrated transfer path and through which the first base film and the second base film which are bonded are transferred, a second pattern formation part configured to coat a top surface of the second base film with a source material on the third transfer path and form a second structured pattern, and a pattern curing part configured to cure the second structured pattern formed on the top surface of the second base film.

Further, the first pattern formation part may include a pattern roller having a preset pattern formed on a surface thereof which is in contact with the source material of the first structured pattern.

Further, the second pattern formation part may include a pattern belt formed in a form of a belt circulating in at least a region on the third transfer path and having a preset pattern formed on a surface thereof which is in contact with the source material of the second structured pattern.

Further, the second pattern formation part may pass through the pattern curing part in a state in which at least a part of the second pattern formation part is in contact with the source material of the second structured pattern.

Further, the second pattern formation part may be formed as a mold, a surface of which is made of a soft material and is in contact with the source material of the second structured pattern.

Further, the first process unit and the second process unit may be continuously connected to each other, and a continuous process may be performed.

Still another aspect of the present invention provides an optical sheet module, which is manufactured using any one of the above-described methods for manufacturing an optical sheet module.

Yet another aspect of the present invention provides an optical sheet module, which includes a first base film, a first structured pattern formed of a UV curing resin on the first base film, an adhesive layer formed of a UV curing resin on a top surface of the first structured pattern, a second base film formed on the adhesive layer, and a second structured pattern formed of a UV curing resin on the second base film, wherein the first structured pattern and the second structured pattern include at least one of an acrylate monomer, diacrylate monomer, urethane acrylate oligomer, polyester acrylate oligomer, epoxy acrylate oligomer, and high refractive acrylate monomer, and the adhesive layer includes at least one of an acrylate monomer, diacrylate monomer, urethane acrylate oligomer, polyester acrylate oligomer, and epoxy acrylate oligomer.

### Advantageous Effects

In order to address the above problems, the present invention has the following effects.

First, a semi-cured first structured pattern is formed on a first base film, an adhesive layer is independently formed on a second base film, the first base film and the second base film are bonded to each other, and then a second structured pattern is formed on a top surface of the second base film. Since different structured patterns are not respectively formed on upper and lower parts of the first base film and the second base film when the first base film and the second base film are bonded, the first base film and the second base film can be stably bonded using conventional bonding rollers.

Second, when the first base film and the second base film are bonded, the upper and lower parts of the first base film and the second base film are pressed using the bonding rollers, and thus the first base film and the second base film can be spaced a uniform distance from each other when being bonded, and the degradation of adhesion quality can be prevented.

Third, a source material of the structured pattern is used in a semi-cured state which is a characteristic of a UV curing material, and thus a penetration depth can be minimized when the first structured pattern is bonded to the adhesive layer so that the degradation of luminance of the optical sheet module can be minimized.

Effects of the present invention are not limited to the above-described effects, and other unmentioned effects may be clearly understood by those skilled in the art based on the following descriptions.

### DESCRIPTION OF DRAWINGS

FIG. 1 is a view showing a process of a first process in a method for manufacturing an optical sheet module according to an embodiment of the present invention.

FIG. 2 is a view showing a process of a second process in the method for manufacturing an optical sheet module according to the embodiment of the present invention.

FIG. 3 is a flowchart showing the method for manufacturing an optical sheet module according to the embodiment of the present invention.

FIG. 4 is a view showing a first process unit of an apparatus for manufacturing an optical sheet module according to an embodiment of the present invention.

FIG. 5 is a view showing a second process unit of the apparatus for manufacturing the optical sheet module according to the embodiment of the present invention.

### MODES OF THE INVENTION

Exemplary embodiments of a method and apparatus for manufacturing an optical sheet module according to the present invention will be described with reference to the accompanying drawings. However, it is not intended to limit the present invention to any particular form, but rather to provide a clear understanding of the present invention.

Further, when the embodiments of the present invention are described, the same components are denoted by the same reference numerals and symbols, and further description thereof will be omitted.

An optical sheet module manufactured according to an embodiment of the present invention may be applied to a backlight unit of a flat liquid crystal display device such as a liquid crystal display (LCD), a light-emitting diode (LED), or the like. However, the optical sheet module manufactured according to the present invention is not necessarily limited thereto. The optical sheet module may be a backlight unit applied to a device other than the liquid crystal display device, or may be applied to any device, such as a lighting device or the like, as long as it changes a characteristic and path of light.

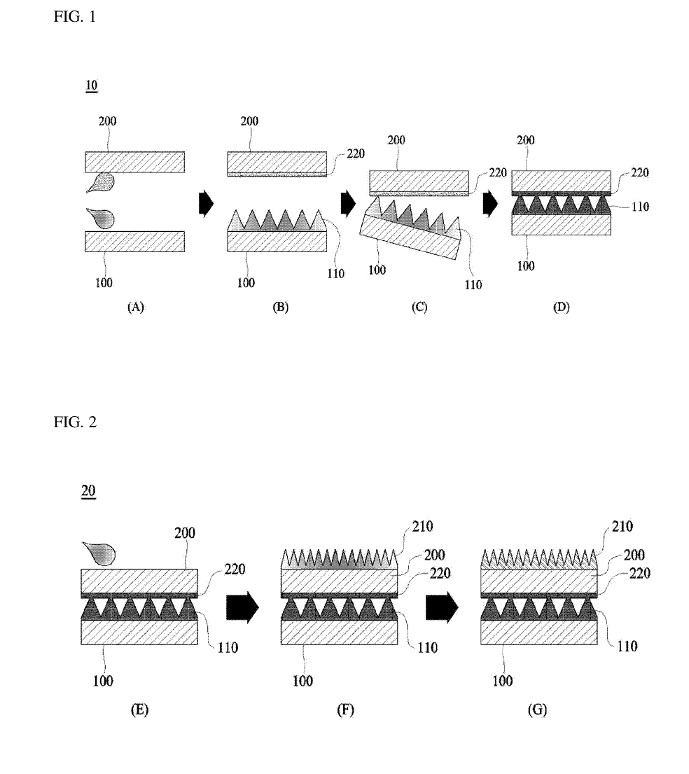

First, a method for manufacturing an optical sheet module according to the present invention will be described with reference to FIGS. 1 to 3.

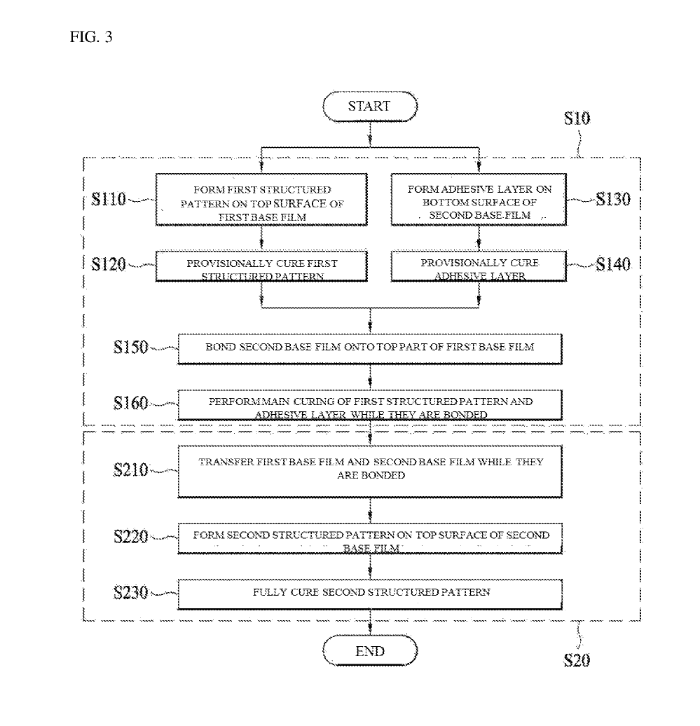

FIG. 1 is a view showing a process of a first process in a method for manufacturing an optical sheet module according to an embodiment of the present invention, FIG. 2 is a view showing a process of a second process in the method for manufacturing an optical sheet module according to the embodiment of the present invention, and FIG. 3 is a flowchart showing the method for manufacturing an optical sheet module according to the embodiment of the present invention.

Referring to the drawings, the method for manufacturing an optical sheet module according to the present invention mainly includes a first process S10 of bonding a first base film 100 on which a first structured pattern 110 is formed to a second base film 200 which is coated with an adhesive layer 220, and a second process S20 of forming a second structured pattern 210 on the second base film 200 in a product on which the first process S10 is performed.

The first process S10 mainly includes a first pattern formation step S110, a provisional pattern curing step S120, an adhesive layer coating step S130, a provisional adhesive layer curing step S140, a bonding step S150, and a main curing step S160.

First, the first pattern formation step S110 of forming the first structured pattern 110 by coating a top surface of the first base film 100 composed of a light-transmitting material with a liquid-state source material is performed.

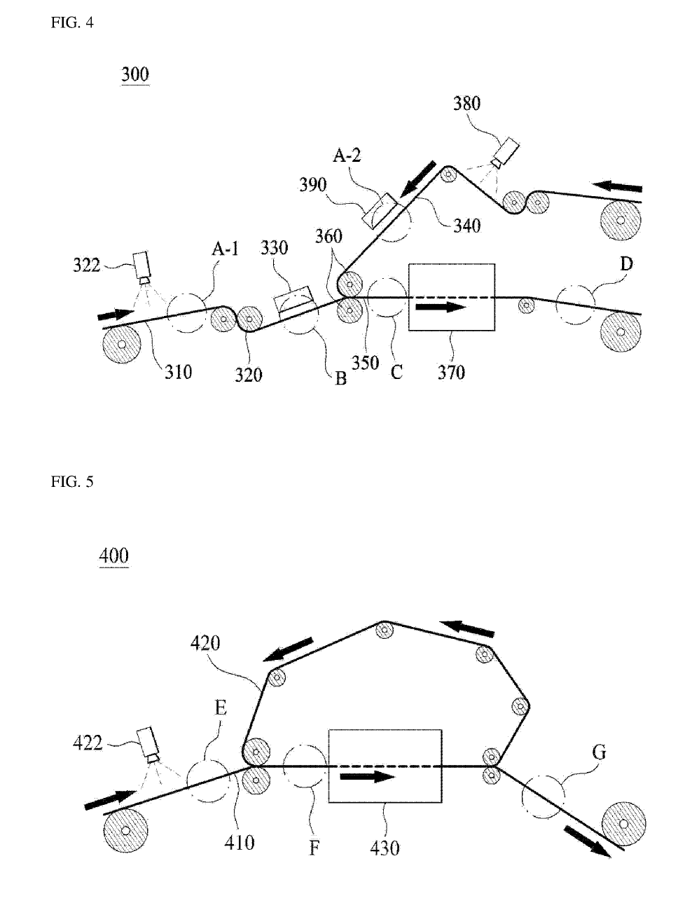

Specifically, the first pattern formation step S110 includes a first process of coating the top surface of the first base film 100 with the liquid-state source material and a second process of forming the first structured pattern 110 by pressing a first pattern formation part 320 (see FIG. 4) in which a preset pattern is formed onto the liquid-state source material with which the first base film 100 is coated.

That is, in the first pattern formation step S110, the top surface of the first base film 100 is coated with the source material and then pressed by the first pattern formation part 320, and thus the preset pattern is formed.

In this case, the first pattern formation part 320 may be provided on a transfer path of the first base film 100 being transferred to be pressed from above. The first pattern formation part 320 may be configured in the form of any one of a pattern roller and a circulating pattern belt having a preset pattern formed on a surface thereof which is in contact with the source material of the first structured pattern 110.

Here, the first base film 100 and the second base film 200 to be described below are composed of a light transmitting film and the materials thereof are not particularly limited. The materials may include polycarbonate (PC), polyethylene terephthalate (PET), polypropylene (PP), polyethylene (PE), polymethyl methacrylate (PMMA), polyimide (PI), a resin, or the like.

Further, a source material for pattern formation of the first structured pattern 110 and the second structured pattern 210 may be any material as long as it is a light-transmitting material and can be cured through ultraviolet (UV) rays. The source material may include at least one of an acrylate monomer, diacrylate monomer, urethane acrylate oligomer, polyester acrylate oligomer, epoxy acrylate oligomer, and high refractive acrylate monomer.

In the embodiment of the present invention, the first pattern formation part 320 is formed as a pattern roller having a pattern formed along a circumference thereof as shown in FIG. 4.

As described above, in the first pattern formation step S110, the top surface of the first base film 100 is coated with the source material to form the first structured pattern 110.

Here, the source material of the first structured pattern 110 is comprised of a light-transmitting material which is a material that can be cured through an additional step.

As described above, the first base film 100 subjected to the step of forming the first structured pattern 110 is subjected to the provisional pattern curing step S120 of provisionally curing the first structured pattern 110 to a semi-cured state while maintaining a shape of the first structured pattern 110.

In the present embodiment, the source material of the first structured pattern 110 may be a material that can be cured through UV rays, and the first structured pattern 110 is semi-cured in a state in which it is bonded to the first pattern formation part 320.

In this case, the first structured pattern 110 is separated from the first pattern formation part 320 in a semi-cured state rather than a fully-cured state.

That is, in the provisional pattern curing step S120, the first structured pattern 110 formed on the first base film 100 is cured to an extent that it is not fully cured but to an extent that only the shape thereof is maintained.

Meanwhile, the adhesive layer coating step S130 is performed separately from the first pattern formation step S110.

Specifically, in the adhesive layer coating step S130, the second base film 200 is provided separately from the first base film 100. The adhesive layer coating step S130 is a step of forming the adhesive layer 220 by coating a surface of the second base film 200 with an adhesive.

Here, the second base film 200 may be formed of the same material as the first base film 100 described above, and the adhesive layer 220 is formed on a surface of the second base film 200.

In this case, a source material of the adhesive layer 220 may be a light-transmitting material like that of the first structured pattern 110 and may be a material that can be cured through UV rays. The adhesive layer 220 may include at least one of an acrylate monomer, diacrylate monomer, urethane acrylate oligomer, polyester acrylate oligomer, and epoxy acrylate oligomer.

Then, after the adhesive layer coating step 130, the provisional adhesive layer curing step S140 of semi-curing the adhesive layer 220 by applying UV rays to the adhesive layer 220 is performed as described above.

In the provisional adhesive layer curing step S140, UV rays are applied to the second base film 200 coated with the adhesive layer 220, and the adhesive layer 220 is semi-cured so as to maintain its shape without being fully cured.

Meanwhile, although not shown, the adhesive layer 220 may be formed to be flat, or may be formed to have an additional uniform or non-uniform pattern.

Then, the bonding step S150 of bonding the first base film 100 subjected to the provisional pattern curing step S120 to the second base film 200 subjected to the provisional adhesive layer curing step S140 is performed.

In the bonding step S150, the second base film 200 is stacked on the first base film 100 and disposed such that the first structured pattern 110 and the adhesive layer 220 face each other. The first base film 100 and the second base film 200 are brought into contact with each other by bonding rollers 360 (see FIG. 4) which will be described below.

In this case, the semi-cured first structured pattern 110 is bonded to the adhesive layer 220 as shown in the drawings.

Here, since the first structured pattern 110 and the adhesive layer 220 are in a semi-cured state, adhesiveness may be increased while the deformation of an upper end part of the first structured pattern 110 is minimized. Further, since the first structured pattern 110 in the semi-cured state comprised of the UV curable material is used, the upper end part of the first structured pattern 110 does not fully penetrate into the adhesive layer 220. Therefore, it is possible to minimize the luminance degradation caused in the optical sheet module.

That is, the bonding step S150 is a process of bonding the semi-cured first structured pattern 110 to the adhesive layer 220. In this step, a penetration depth of the first structured pattern 110 may be reduced to minimize the damage.

Further, since the first structured pattern 110 and the adhesive layer 220 are bonded to each other in the semi-cured state and are then cured, bonding quality may also be increased.

In the present embodiment, the second base film 200 is configured to be bonded to the first structured pattern 110 in a state in which the adhesive layer 220 is formed on a bottom surface of the second base film 200. Alternatively, the first structured pattern 110 may be directly bonded to the bottom surface of the second base film 200 without the adhesive layer 220.

As described above, in the bonding step S150, the second base film 200 is bonded to a lower part of the first base film 100 on which the first structured pattern 110 is formed.

After the bonding step S150, the main curing step S160 is performed.

The main curing step S160 is a process of fully curing the first structured pattern 110 in a state in which the first base film 100 and the second base film 200 are bonded to each other in a stacked form.

Specifically, the first base film 100 and the second base film 200 are transferred in a bonded state and pass through a separate main curing part 370 (see FIG. 4), and the first structured pattern 110 may be fully cured by heat, UV rays, or the like.

The first base film 100 and the second base film 200 are fully bonded by the above process.

As described above, in the first process S10, the first structured pattern 110 may be formed in a semi-cured state on the top surface of the first base film 100, the bottom surface of the second base film 200 may be coated with the adhesive layer 220 to form the second base film 200 in a semi-cured state, the first structured pattern 110 and the second base film 200 may then be bonded to each other, the first structured pattern 110 may be formed between the first base film 100 and the second base film 200 by performing main curing on the first structured pattern 110 and the adhesive layer 220, and at the same time, the first base film 100 and the second base film 200 may be bonded to each other.

Of course, unlike the present embodiment, in the first process S10, the adhesive layer coating step S130 may be excluded, and the second base film 200 may be bonded to the first base film 100 in a state in which the adhesive layer 220 is not present on the bottom surface of the second base film 200.

In this case, the upper end part of the first structured pattern 110, which is formed in the semi-cured state on the top surface of the first base film 100, may be directly bonded to the bottom surface of the second base film 200, and a part of the semi-cured first structured pattern 110 may serve as an adhesive.

Next, the second process S20 in the method for manufacturing an optical sheet module according to the embodiment of the present invention will be described.

The second process S20 is a process of additionally processing a sheet of a bonded structure in which the first base film 100 and the second base film 200 are bonded by the first process S10 described above and mainly includes a transferring step S210, a second pattern formation step S220, and a pattern curing step S230.

The transferring step S210 is a process of transferring the first base film 100 and the second base film 200 in a bonded state. In the transferring step S210, the bonded structure manufactured by the first process S10 is transferred.

In the second pattern formation step S220, the second structured pattern 210 is formed on a top surface of the second base film 200 subjected to the main curing step S160. Here, similar to the process of forming the first structured pattern 110 of the first base film 100 described above, the top surface of the second structured pattern 210 is coated with a source material of the second structured pattern 210.

Then, the second structured pattern 210 is brought into contact with the source material of the second structured pattern 210 by a separate second pattern formation part 420 (see FIG. 5) to form a pattern.

Here, the source material of the second structured pattern 210 is also made of a light-transmitting material.

In this case, the second pattern formation part 420 may be configured similarly to the first pattern formation part 320 described above and may be formed in the form of a pattern roller or a circulating pattern belt having a preset pattern formed on a surface thereof to form the second structured pattern 210.

Here, the second pattern formation part 420 may be formed as a mold, a surface of which is comprised of a soft material and is in contact with the source material of the second structured pattern 210. Specifically, a soft material such as rubber or the like may be used as the mold for forming the pattern on the pattern belt, and thus damage of the pre-formed first structured pattern 110 may be minimized.

Meanwhile, the second structured pattern 210 formed by the second pattern formation part 420 may be configured to have a pitch or a vertical height different from that of the first structured pattern 110 described above.

That is, a pattern formed on a surface of the first pattern formation part 320 for forming the first structured pattern 110, which is in contact with the source material of the first structured pattern 110, is formed to be different from the pattern formed on a surface of the second pattern formation part 420, which is in contact with the source material of the second structured pattern 210.

Then, the second pattern formation part 420 passes through a separate pattern curing part 430 (see FIG. 5) while in contact with the top surface of the second base film 200, and the pattern curing step S230 of curing the second structured pattern 210 is performed.

As described above, in the second process S20, the second structured pattern 210 is additionally formed on a top surface of the bonded structure in which the first base film 100 and the second base film 200 are bonded by the first process S10.

Accordingly, an optical sheet module, which is the bonded structure in which the first structured pattern 110 is formed on the first base film 100 and the second structured pattern 210 is formed on the top surface of the second base film 200, may be manufactured.

The optical sheet module manufactured using the above-described steps utilizes a semi-cured state, which is a characteristic of a UV curing material. Therefore, a penetration depth may be minimized and bonding quality may be increased when the first structured pattern 110 and the adhesive layer 220 are bonded, thereby minimizing the luminance degradation of the optical sheet module.

Next, an apparatus for manufacturing an optical sheet module according to an embodiment of the present invention will be described with reference to FIGS. 4 and 5.

FIG. 4 is a view showing a first process S10 of an apparatus for manufacturing an optical sheet module according to an embodiment of the present invention, and FIG. 5 is a view showing the second process S20 of the apparatus for manufacturing the optical sheet module according to the embodiment of the present invention.

First, FIG. 4 shows a first process unit 300 which performs the above-described first process S10, and the first process unit 300 mainly includes a first transfer path 310, a first pattern formation part 320, a provisional pattern curing part 330, a second transfer path 340, an adhesive layer coating part 380, an integrated transfer path 350, a provisional adhesive layer curing part 390, the bonding rollers 360, and a main curing part 370.

The first transfer path 310 is a path through which the first base film 100 in the form of a sheet is transferred, and the first transfer path 310 is formed in the form of a general conveyor.

The first base film 100 is placed on a top surface of the first transfer path 310 and transferred in a longitudinal direction.

In this case, the first transfer path 310 is formed in the form of a roller, and the first base film 100 is transferred by a plurality of rollers.

Meanwhile, the first pattern formation part 320 is provided on the first transfer path 310 to form the first structured pattern 110 on the top surface of the first base film 100.

Specifically, as shown in the drawing, the first pattern formation part 320 is provided on the path through which the first base film 100 moves to form the first structured pattern 110 on the top surface of the first base film 100.

In the present embodiment, the first pattern formation part 320 is formed as a pattern roller which has a preset pattern on an outer circumferential surface thereof and is disposed to be in contact with the top surface of the first base film 100.

The first base film 100 receives a source material of the first structured pattern 110, which is injected from an inlet part 322 separately provided in a region A-1 before passing through the first pattern formation part 320, on the first transfer path 310, and becomes a state shown in (A) of FIG. 1.

Thereafter, the source material which is injected onto the top surface of the first base film 100 passes through a region B, and the first structured pattern 110 is formed as shown in (B) of FIG. 1.

As described above, the first pattern formation part 320 is provided between the region A and the region B, and forms the first structured pattern 110 on the top surface of the first base film 100.

Then, the provisional pattern curing part 330 maintains the first structured pattern 110 in a semi-cured state by applying heat or UV rays to the first base film 100 after the first base film 100 passes through the first pattern formation part 320.

Specifically, the provisional pattern curing part 330 is positioned in the region B and solidifies the first structured pattern 110 while maintaining a shape of the first structured pattern 110 and cures the first structured pattern 110 to only be in a state capable of changing the shape of the first structured pattern 110 due to an external force.

This is so as to not fully cure the first structured pattern 110 for stable bonding between the first structured pattern 110 and the second base film 200.

As described above, the first base film 100 is moved along the first transfer path 310 in a state in which the first structured pattern 110 is semi-cured by the provisional pattern curing part 330.

Meanwhile, the second transfer path 340 transfers the second base film 200 separately from the first transfer path 310 described above.

Here, the first base film 100 and the second base film 200 may be configured in the same manner and are individually transferred through the second transfer path 340.

In this case, the second transfer path 340 is disposed such that an end part thereof in a direction being transferred merges with the first transfer path 310 described above.

Therefore, the first base film 100 transferred along the first transfer path 310 and the second base film 200 transferred along the second transfer path 340 meet in a stacked form at the end part of the second transfer path 340 in the direction in which they are transferred and are bonded to each other, as shown in (C) of FIG. 1.

In the present embodiment, the first transfer path 310 and the second transfer path 340 are connected such that the second base film 200 transferred along the second transfer path 340 is stacked on the first base film 100.

Meanwhile, the first process unit 300 according to the present invention may further include the adhesive layer coating part 380 and the provisional adhesive layer curing part 390.

Specifically, the adhesive layer coating part 380 is provided on the second transfer path 340, and the bottom surface of the second base film 200 is uniformly coated with the adhesive layer 220, as shown in (B) of FIG. 1.

In this case, a flat surface of the second base film 200 may be uniformly coated with the adhesive layer 220, or may be coated with the adhesive layer 220 having a specific pattern.

As described above, the second base film 200 is transferred to a region A-2 of FIG. 4 along the second transfer path 340 while coated with the adhesive layer 220.

The provisional adhesive layer curing part 390 is positioned on a downstream side of the adhesive layer coating part 380 along the second transfer path 340 and semi-cures the adhesive layer 220 with which the second base film 200 is coated.

Specifically, the provisional adhesive layer curing part 390 is positioned on region B of FIG. 4 to apply UV rays to the adhesive layer 220. In this case, the adhesive layer 220 is comprised of a material which is cured by UV rays, as described above, and the curing is performed in region B.

Here, the provisional adhesive layer curing part 390 maintains the adhesive layer 220, with which the second base film 200 is coated, in a semi-cured state rather than fully cured state.

The integrated transfer path 350 is connected to each of downstream sides of the first transfer path 310 and the second transfer path 340 to be merged with each other, and the first base film 100 and the second base film 200 are transferred therethrough.

In this case, the bonding rollers 360 which bond the second base film 200 to the first base film 100, are provided in a region in which the first transfer path 310 and the second transfer path 340 are merged and the second base film 200 and the first base film 100 are transmitted to the integrated transfer path 350.

The bonding rollers 360 are each disposed on the first base film 100 and below the second base film 200, and the first base film 100 and the second base film 200 pass through the bonding rollers 360 in a stacked state so as to be bonded to each other.

Specifically, the bonding rollers 360 are provided at a point at which the first transfer path 310 and the second transfer path 340 meet and the second base film 200 is stacked on the first base film 100, and the bonding rollers 360 are vertically disposed at consistent intervals.

Therefore, the first base film 100 and the second base film 200 pass through the bonding rollers 360 in the form in which the upper end part of the first structured pattern 110 formed on the top surface of the first base film 100 is in contact with the adhesive layer 220 formed on the bottom surface of the second base film 200 in a stacked state.

Accordingly, the adhesive layer 220 formed on the second base film 200 and the upper end part of the first structured pattern 110 formed on the first base film 100 are pressed and bonded in a region C of FIG. 4, as shown in (C) of FIG. 1.

In this case, since the first structured pattern 110 and the adhesive layer 220 are not fully cured, the shape of the upper end part of the first structured pattern 110 and the shape of the adhesive layer 220 formed on the bottom surface of the second base film 200 are partially deformed due to the pressing of the bonding rollers 360, and the first structured pattern 110 and the adhesive layer 220 are bonded to each other.

Here, since the adhesive layer 220 is also semi-cured, the upper end part of the first structured pattern 110 may partially penetrate into the adhesive layer 220 without fully penetrating thereinto, thereby minimizing the damage of the pattern.

Meanwhile, the main curing part 370 is provided on the integrated transfer path 350 and fully cures the first structured pattern 110 and the adhesive layer 220, which are bonded to each other.

Specifically, the main curing part 370 is configured to cure the first structured pattern 110 using heat or UV rays as described above. The first base film 100 and the second base film 200, which pass through the main curing part 370 as described above, become a fully bonded structure in a region D of FIG. 4 as shown in (D) of FIG. 1.

As described above, in the first process unit 300 according to the present invention, the first structured pattern 110 and the adhesive layer 220 are independently formed on the first base film 100 and the second base film 200, respectively, and then are bonded to each other in a semi-cured state and fully cured at the same time, and thus an optical sheet with a bonded structure is manufactured.

Then, as shown in FIG. 5, a second process unit 400 includes a third transfer path 410, a second pattern formation part 420, and a pattern curing part 430.

The third transfer path 410 is formed separately from the integrated transfer path 350 described above and is configured to receive a bonded structure in which the second base film 200 is bonded onto the first base film 100 and transfer the bonded structure to a target position.

Specifically, the third transfer path 410 is formed in the form of a general roller or conveyor and receives the first base film 100 and the second base film 200, which are bonded by the first process unit 300, from one side and then transfers them. In the present embodiment, the third transfer path 410 is provided separately from the integrated transfer path 350 so that the first process unit 300 and the second process unit 400 are individually configured. Alternatively, the third transfer path 410 and the integrated transfer path 350 may be continuously connected to each other and thus a continuous process may be performed.

Meanwhile, the second pattern formation part 420 is provided on the third transfer path 410 so that the top surface of the second base film 200 is coated with the source material to form the second structured pattern 210.

Specifically, the second pattern formation part 420 may be formed similarly to the first pattern formation part 320. Alternatively, in the present embodiment, the second pattern formation part 420 is formed as a pattern belt formed in the form of a belt circulating in at least a region on the third transfer path 410 and having a preset pattern on a surface thereof which is in contact with the source material of the second structured pattern 210. Therefore, the second pattern formation part 420 is brought into contact with the top surface of the second base film 200 which is transferred along the third transfer path 410 to form the second structured pattern 210.

Of course, alternatively, the second pattern formation part 420 may be formed in the form of a pattern roller like the first pattern formation part 320 described above.

Here, the first pattern formation part 320 and the second pattern formation part 420 may use a soft material, such as rubber or the like, as a mold for forming a pattern. Accordingly, damage to the shape of the second structured pattern 210 formed by the second pattern formation part 420 or damage such as scratches or the like may be prevented.

In addition, as described above, a pitch or vertical height of the second structured pattern 210 may be different from that of the first structured pattern 110. Accordingly, the pattern formed on a surface of the first pattern formation part 320 in contact with the first structured pattern 110 and the pattern formed on a surface of the second pattern formation part 420 in contact with the second structured pattern 210 may be formed to have different pitches or vertical heights.

Meanwhile, the second base film 200 receives the source material of the second structured pattern 210, which is injected from a separate inlet part 422 in region E as shown in (E) of FIG. 2 before passing through the second pattern formation part 420, on the third transfer path 410.

Thereafter, the source material which is injected onto the top surface of the second base film 200 passes through a region F and is formed as the second structured pattern 210 as shown in (F) of FIG. 2.

Then, the pattern curing part 430 fully cures the second structured pattern 210, which is formed on the top surface of the second base film 200, on the third transfer path 410.

Specifically, the pattern curing part 430 may be formed similarly to the main curing part 370 described above. The first base film 100 and the second base film 200 may be transferred along the third transfer path 430 in a bonded state so that the second structured pattern formed by the second pattern formation part 420 may be fully cured.

Here, the second pattern formation part 420 formed as the pattern belt may be configured to pass through the pattern curing part 430 in a state in which at least a part of the second pattern formation part 420 is in contact with the source material of the second structured pattern 210. Accordingly, the second pattern formation part 420 may cure the second structured pattern 210 while stably maintaining the shape of the second structured pattern 210.

That is, the second base film 200 passes through the pattern curing part 430 in a state in which the second structured pattern 210 is formed on the top surface thereof so that the second structured pattern 210 may be fully cured in region G as shown in (G) of FIG. 2.

As described above, in the second process unit 400 according to the present invention, the second structured pattern 210 is additionally formed on the bonded structure of the first base film 100 and the second base film 200 which are provided by the first process unit 300, and thus an optical sheet module, in which the first structured pattern 110 and the second structured pattern 210 are respectively formed on the top surfaces of the first base film 100 and the second base film 200 and at the same time are bonded to each other, may be manufactured.

Accordingly, since no separate structured pattern is formed on the top surfaces of the first base film 100 and the second base film 200 when the first base film 100 and the second base film 200 are bonded, the first base film 100 and the second base film 200 may be easily bonded using the bonding rollers 360.

Further, the first base film 100 and the second base film 200 are pressed upward and downward using the bonding rollers 360 when the first base film 100 and the second base film 200 are bonded, and thus the first base film 100 and the second base film 200 may be spaced at a uniform distance from each other when the first base film 100 and the second base film 200 are bonded, and lowering of adhesion quality may be prevented.

Therefore, in the present invention, the first base film 100 and the second base film 200 may be bonded more stably than in a conventional system in which structured patterns are each formed on top surfaces of a pair of optical sheets and then the pair of optical sheets are bonded to each other.

The exemplary embodiments of the present invention have been described. In addition to the embodiments described above, the present invention may be embodied in other forms without departing from the spirit or scope of the present invention. Therefore, the embodiments should be considered as only examples in all aspects and not for purposes of limitation. Accordingly, the present invention is not limited to the above description, but may be modified within the scope of the appended claims and the equivalents thereof.

1. A method for manufacturing an optical sheet module, the method comprising:
a first pattern formation step of coating a top surface of a first base film with a liquid-state source material so as to form a first structured pattern;
a provisional pattern curing step of semi-curing the first structured pattern while maintaining its shape;
an adhesive layer coating step of coating a surface of a second base film with an adhesive layer;
a provisional adhesive layer curing step of semi-curing the adhesive layer coated on the second base film;
an adhesion step of adhering at least a part of the first structured pattern of the first base film to a bottom surface of the second base film; and
a main curing step of curing the first structured pattern while the first base film and the second base film are adhered.

2. The method of claim 1, further comprising:
a second pattern formation step of coating a top surface of the second base film subjected to the main curing step with a liquid-state source material so as to form a second structured pattern; and
a pattern curing step of curing the second structured pattern.

3. The method of claim 2, wherein the adhesive layer is formed to have a preset pattern.

4. The method of claim 1, wherein the first pattern formation step includes:
a first process of coating the top surface of the first base film with the liquid-state source material of the first structured pattern; and
a second process of forming the first structured pattern by pressing a first pattern formation part in which a preset pattern is formed onto the source material with which the first base film is coated.

5. The method of claim 4, wherein the first pattern formation part is formed as any one of a pattern roller and a circulating pattern belt having a preset pattern formed on a surface thereof which is to make contact with the source material of the first structured pattern.

6. The method of claim 1, wherein the first structured pattern has a pitch or a vertical height different from the second structured pattern.

7. The method of claim 2, wherein the first structured pattern, the second structured pattern, and the adhesive layer are comprised of ultraviolet (UV) curable materials.

8. The method of claim 7, wherein the first structured pattern and the second structured pattern include at least one of acrylate monomer, diacrylate monomer, urethane acrylate oligomer, polyester acrylate oligomer, epoxy acrylate oligomer, and high refractive acrylate monomer.

9. The method of claim 7, wherein the adhesive layer includes at least one of acrylate monomer, diacrylate monomer, urethane acrylate oligomer, polyester acrylate oligomer, and epoxy acrylate oligomer.

10. An apparatus for manufacturing an optical sheet module, the apparatus comprising:
a first process unit including a first transfer path through which a first base film in a form of a sheet is transferred, a first pattern formation part configured to form a first structured pattern on a top surface of the first base film on the first transfer path, a provisional pattern curing part configured to semi-cure the first structured pattern formed by the first pattern formation part so as to maintain a shape of the first structured pattern, a second transfer path provided separately from the first transfer path and through which a second base film in a form of a sheet is transferred, an adhesive layer coating part provided on the second transfer path and configured to form an adhesive layer on a surface of the second base film which is transferred onto the second transfer path, a provisional adhesive layer curing part provided on the second transfer path and configured to semi-cure the adhesive layer which is transferred onto the second transfer path, an integrated transfer path connected to each of downstream sides of the first transfer path and the second transfer path to be merged with each other and through which the first base film and the second base film are transferred, a bonding roller provided on the integrated transfer path and configured to stack the second base film on the first base film and bond the first structured pattern to the adhesive layer by pressing upward and downward, and a main curing part configured to cure the first structured pattern and the adhesive layer which are bonded on the integrated transfer path; and
a second process unit including a third transfer path provided separately from the integrated transfer path and through which the first base film and the second base film which are bonded are transferred, a second pattern formation part configured to coat a top surface of the second base film with a source material on the third transfer path and form a second structured pattern, and a pattern curing part configured to cure the second structured pattern formed on the top surface of the second base film.

11. The apparatus of claim 10, wherein the first pattern formation part includes a pattern roller having a preset pattern formed on a surface thereof which is to make contact with the source material of the first structured pattern.

12. The apparatus of claim 10, wherein the second pattern formation part includes a pattern belt formed in a form of a belt circulating in at least a region on the third transfer path and having a preset pattern formed on a surface thereof which is to make contact with the source material of the second structured pattern.

13. The apparatus of claim 12, wherein the second pattern formation part passes through the pattern curing part in a state in which at least a part of the second pattern formation part is in contact with the source material of the second structured pattern.

14. The apparatus of claim 12, wherein the second pattern formation part is formed as a mold, a surface of which is made of a soft material and is in contact with the source material of the second structured pattern.

15. The apparatus of claim 10, wherein the first process unit and the second process unit are continuously connected to each other, and a continuous process is performed.

16. An optical sheet module, which is manufactured using the method for manufacturing an optical sheet module of claim 1.

17. An optical sheet module comprising:
a first base film;
a first structured pattern formed of an ultraviolet (UV) curing resin on the first base film;
an adhesive layer formed of a UV curing resin on a top surface of the first structured pattern;
a second base film formed on the adhesive layer; and
a second structured pattern formed of a UV curing resin on the second base film,
wherein the first structured pattern and the second structured pattern include at least one of acrylate monomer, diacrylate monomer, urethane acrylate oligomer, polyester acrylate oligomer, epoxy acrylate oligomer, and high refractive acrylate monomer, and
the adhesive layer includes at least one of acrylate monomer, diacrylate monomer, urethane acrylate oligomer, polyester acrylate oligomer, and epoxy acrylate oligomer.
